(19) United States
(12) Patent Application Publication
(10) Pub. No.: US 2026/0219712 A1
(43) Pub. Date: Jul. 30, 2026

(54) INFORMATION HANDLING SYSTEM VARIABLE TORQUE HINGE

(71) Applicant: Dell Products L.P., Round Rock, TX (US)

(72) Inventors: Wen-Chieh Wang, Taipei (TW); Anthony J. Sanchez, Pflugerville, TX (US); Jieh-I Taur, Taipei (TW); Chih-Chien Cheng, Taipei (TW)

(73) Assignee: Dell Products L.P., Round Rock, TX (US)

(21) Appl. No.: 19/039,014

(22) Filed: Jan. 28, 2025

(51) Int. Cl. G06F 1/16

(52) U.S. Cl. CPC G06F 1/1681

(57) ABSTRACT

A portable information handling system housing main portion rotates relative to a lid portion about a variable torque hinge that has a lower torque when rotating to an open position than to a closed position. A variable torque engine inserts on the hinge axle between a dual-direction torque engine and the hinge brackets to generate torque when the axle rotates in the closed direction by engaging with and rotating with the axle and frees the axle to rotate separately when rotating in the open direction thereby creating near zero torque. Bearings within channels of a sleeve of the variable torque engine lock the sleeve to the axle when rotating in the closed direction by engaging with an inclined surface within the channel.

### BACKGROUND OF THE INVENTION

### Field of the Invention

The present invention relates in general to the field of portable information handling systems, and more particularly to an information handling system variable torque hinge.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems integrate processing components, a display and a power source in a portable housing to support mobile operations. Portable information handling systems allow end users to carry a system between meetings, during travel, and between home and office locations so that an end user has access to processing capabilities while mobile. Tablet configurations typically expose a touchscreen display on a planar housing that both outputs information as visual images and accepts inputs as touches. Convertible configurations typically include multiple separate housing portions that couple to each other so that the system converts between closed and open positions. For example, a main housing portion integrates processing components and a keyboard and rotationally couples with hinges to a lid housing portion that integrates a display. In a clamshell configuration, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility.

One difficulty with convertible information handling systems is getting the amount of torque associated with the hinge at a level that provides ease of opening while firmly holding the housing closed and at an open position selected by an end user. Large torque values prohibit an easy opening of the housing when an end user generally has to insert a fingertip between the housing main portion and lid portion to lift the lid portion upwards and away from the main portion. If hinge torque is too high the end user will have difficulty prying the housing portions apart. If the hinge torque is too low, then the housing portions may not hold their position when an end user reaches a desired rotational orientation. The design of the hinge is further complicated by the thin size of portable information handling systems and the number of cycles that a hinge has to endure without excessive loss of torque. One solution to provide easy opening of a housing while holding the housing in position once opened is to include a torque engine that varies hinge torque during opening and closing of the housing. For example, a cam or other mechanism in the hinge axis might increase torque during some rotational ranges while a reduced axis circumference at the closed position helps to reduce torque when an end user tries to open the housing. These types of arrangements tend to wear unevenly as the hinge cycles. Other devices selectively engage and release torque, however, these types of arrangements tend to add complexity, cost and size to the hinge.

### SUMMARY OF THE INVENTION

Therefore, a need has arisen for a system and method which adjusts a hinge torque to resist rotation of an information handling system housing at different levels when opening versus closing the housing.

In accordance with the present invention, a system and method are provided which substantially reduce the disadvantages and problems associated with previous methods and systems for generating torque at an information handling system housing hinge. A sleeve inserted around an axle of the hinge encloses a bearing that engages with the sleeve when the axle rotates in a first direction so that the sleeve rotates with the axle to generate torque by friction of engagement of the sleeve ends with the hinge. When the axle rotates in a second direction, the bearing rotates in the sleeve to free the sleeve from rotation with the axle, thereby generating near zero torque relative to rotation in the first direction.

More specifically, a portable information handling system processes information with a processor and memory coupled in a housing main portion and presents the information at a display coupled in a housing lid portion. The housing main and lid portions rotationally couple to each other by a variable torque hinge that resists rotation to a closed position with a greater torque than rotation to an open position. A dual-direction torque engine resists rotation in both the open and closed directions, such as with friction washers compressed by a nut at one end of the hinge axle. A variable torque engine resists rotation in the closed direction while providing near zero torque against rotation in the open direction. In one example embodiment, the variable torque engine comprises a sleeve inserted on the hinge axle and having plural splines extending out from the axle to define channels between the sleeve and the axle, each channel having an incline on one side and a cylindrical bearing disposed within the channel. When rotation of the axle biases the bearing towards the incline, the bearing engages the sleeve to rotate with the axle so that the ends of the sleeve generate friction against compressed sides of the hinge. When rotation of the axle biases the bearing away from incline, the sleeve is free from the axle so that the axle rotates within the sleeve, thereby generating near zero torque.

The present invention provides a number of important technical advantages. One example of an important technical advantage is that an information handling system hinge provides variable torque to offer movement from a closed position to an open position with less resistance than rotation from an open position to a closed position. An end user is better able to pry open the housing when closed by inserting a fingertip between the housing portions given the reduced resistance to rotation. When in the open position, the housing portions have a greater resistance to rotate to the closed position so that the housing is held secure for use. The variable torque engine has a minimal footprint and operates with a dual-direction torque engine to provide precise management of housing rotation torque between open and closed positions.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a portable information handling system having a housing with main and lid portions rotationally coupled by a variable torque hinge;

FIG. 2 depicts an example embodiment of a variable torque hinge that generates greater torque when rotating in a first direction compared to a second direction;

FIG. 3 depicts the example embodiment of the variable torque hinge having the variable torque engine partially inserted onto the hinge axle;

FIGS. 4 and 4A depict a side sectional view of the example embodiment of the variable torque hinge inserted onto the hinge axle;

FIG. 5 depicts an exploded perspective view of the example embodiment of the variable torque hinge;

FIGS. 6 and 6A depict an alternative embodiment of the variable torque hinge rotating to an open position having near zero torque; and

FIGS. 7 and 7A depict an alternative embodiment of the variable torque hinge rotating to a closed position and generating torque to resist rotation.

### DETAILED DESCRIPTION

A portable information handling system housing rotates about a hinge having a variable torque that resists rotation when rotating the housing from an open position to a closed position while providing little resistance when rotating from the closed position to an open position. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

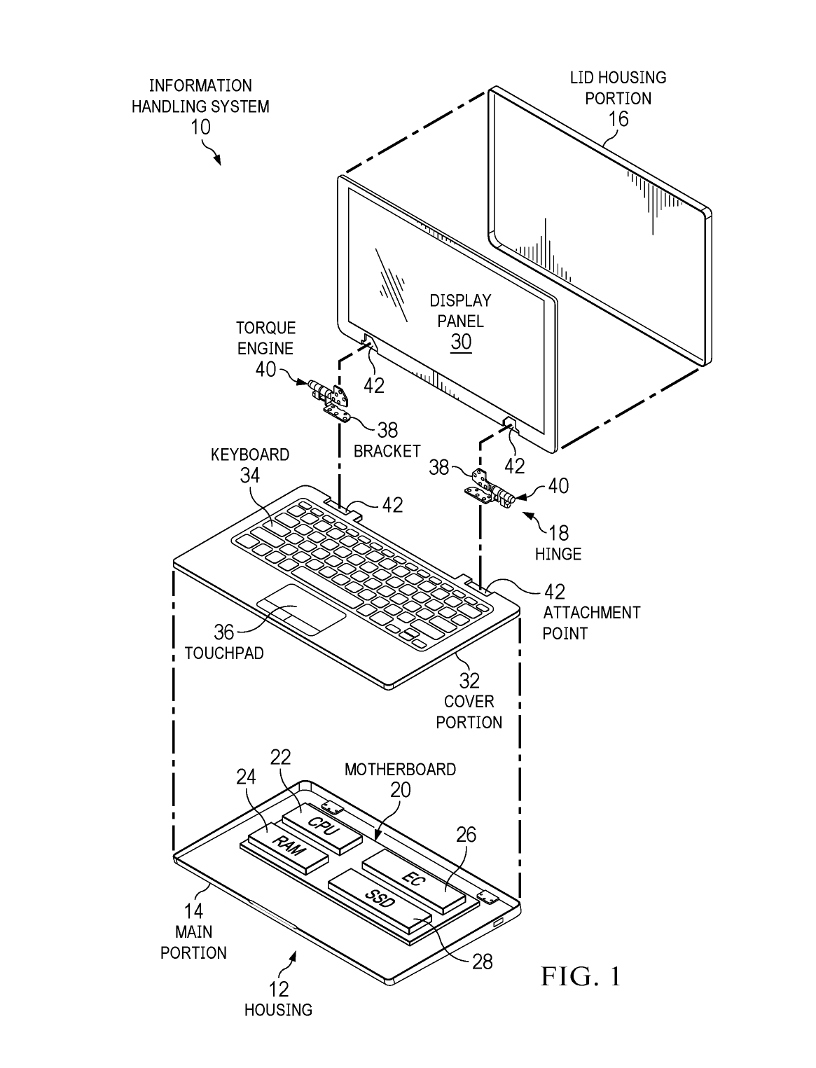

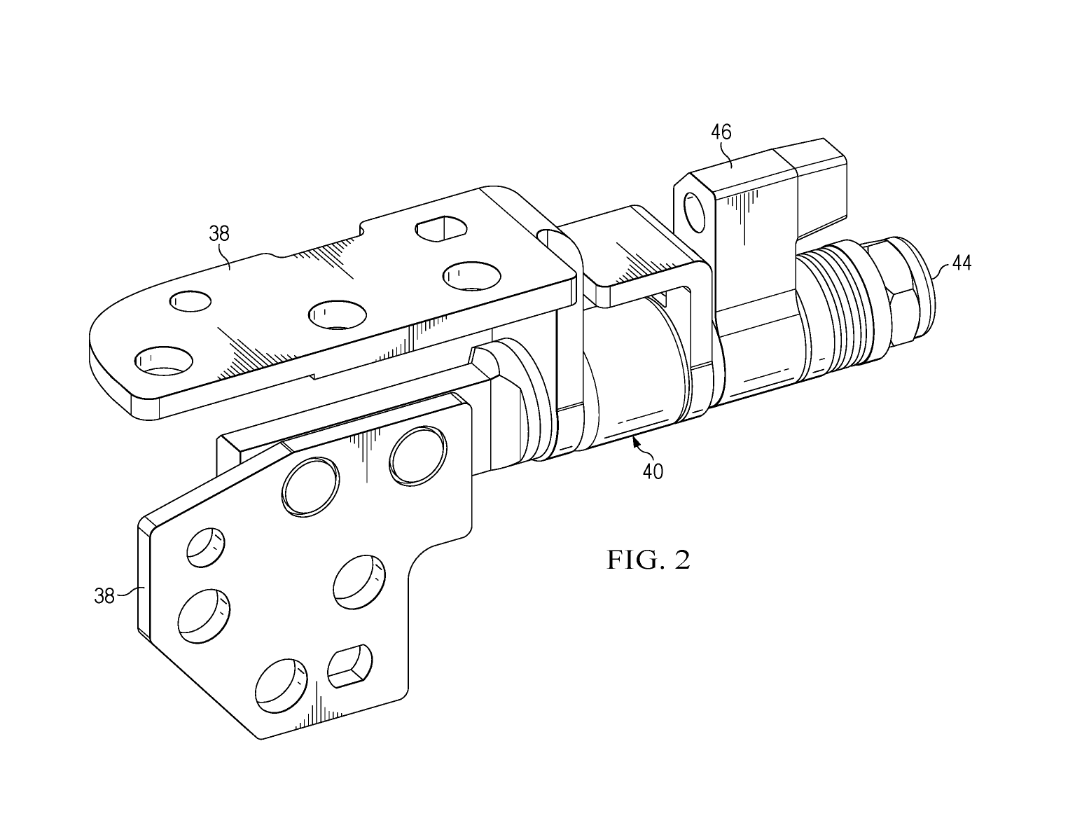

Referring now to FIG. 1, a portable information handling system 10 is depicted having a housing 12 with main and lid portions rotationally coupled by a variable torque hinge 18. In the example embodiment, information handling system 10 has a convertible configuration with a main portion 14 that contains processing components that cooperate to process information. A motherboard 20 interfaces a central processing unit (CPU) 22 that executes instructions to process information with a random access memory (RAM) 24 that stores the instructions and information. An embedded controller 26 manages operating conditions of the information handling system and interacts with external devices, such as input/output devices. A solid state drive (SSD) 28 provides non-transitory storage of an operating system and applications that are retrieved to RAM 24 at system power up. A housing cover portion 32 couples over main portion 14 to enclose the processing components and support a keyboard 34 and touchpad 36 that accept end user inputs. A display panel 30 couples into housing lid portion 16 and interfaces with CPU 22 to present information as visual images.

Housing main portion 14 and lid portion 16 each include attachment points 42 to couple with a bracket 38 of hinge 18, such as with screws. Once housing 12 rotationally couples main portion 14 and lid portion 16, the housing rotates between a closed position that brings display panel 30 against keyboard 34 and an open position that raises display panel 30 to a viewing position roughly perpendicular to keyboard 34. Each hinge 18 includes a variable torque engine 40 that resists rotation of the housing main and lid portions relative to each other. When opening housing 12, the torque generated by variable torque engine 40 is less that the torque generated when closing housing 12. The reduced resistance to rotation during opening of housing 12 provides a better end user experience by supporting rotation when the end user has to insert fingertips between the main and lid portion to pry the housing from a fully closed position to an open position. The increased resistance to rotation during closing of housing 12 helps to ensure that the housing does not move when an end user rotates the housing to a desire open position rotational orientation.

Referring now to FIG. 2, an example embodiment depicts a variable torque hinge that generates greater torque when rotating in a first direction compared to a second direction. In the example embodiment, brackets 38 couple to an axle 44 to rotate relative to each other. Variable torque engine 40 is compressed between brackets 38 and a main body 46 that includes a dual-direction torque engine as described in greater detail below. Compression of variable torque engine 40 between brackets 38 and main body 46 puts pressure against both ends of variable torque engine 40. When variable torque engine 40 engages to rotate with axle 44, the compression generates torque in response to friction between the ends of variable torque engine 40 and the bracket 38 and main body, which do not rotate with the axle. When variable torque engine 40 does not engage, the ends remain stationary relative to bracket 38 and main body 46 so that axle 44 rotates within the variable torque engine. When the axle rotates within variable torque engine 40, near zero torque is generated relative to when the axle and variable torque engine rotate together as the only friction is nominal and incidental to the movement of a bearing within variable torque engine 40 as described below in greater detail.

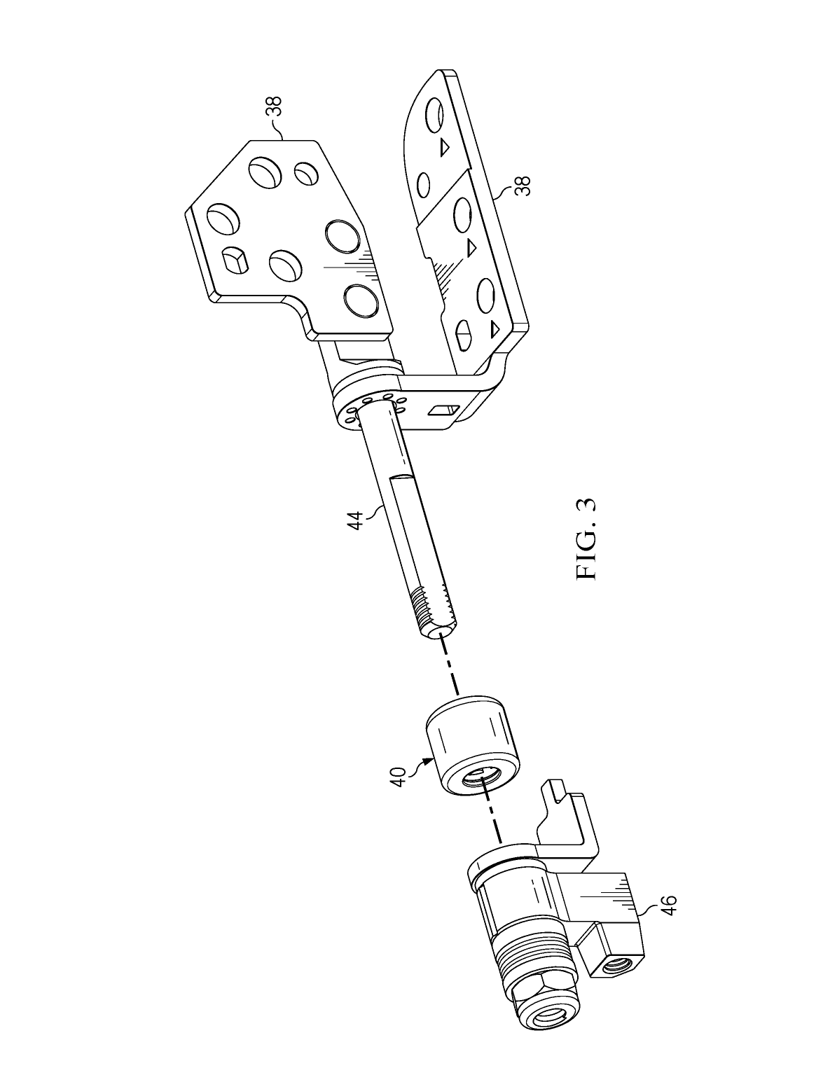

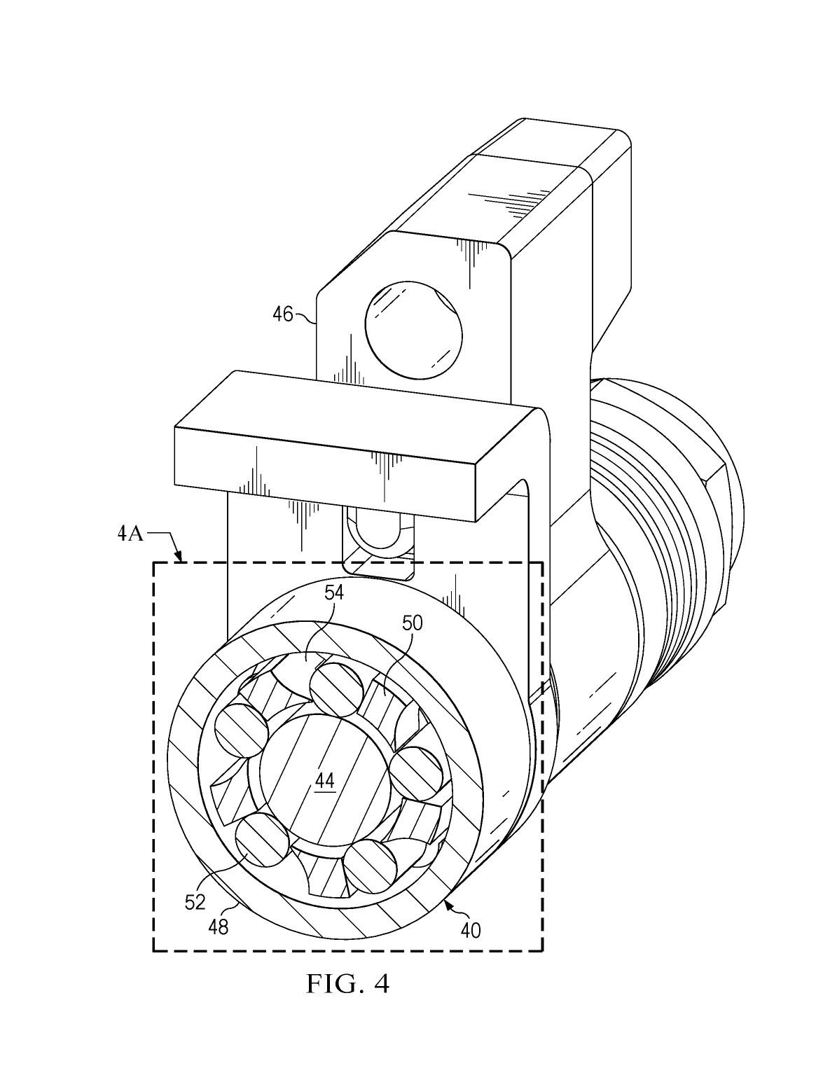

Referring now to FIG. 3, the example embodiment depicts the variable torque hinge having the variable torque engine 40 partially inserted onto the hinge axle 44. In the example embodiment, main body 46 extends a pin into an opening of bottom bracket 38 to hold main body 46 and the bottom bracket 38 stationary relative to each other. Variable torque engine 40 inserts on axle 44 to compress one end against the bottom bracket 38 and the other end against main body 46. Friction is provided by both ends of variable torque engine 40 engaging on one end against bracket 38 and at the other end against main body 46. Friction creates torque when variable torque engine 40 rotates with axle 44 and not when variable torque engine 40 is stationary relative to main body 46 and lower bracket 38.

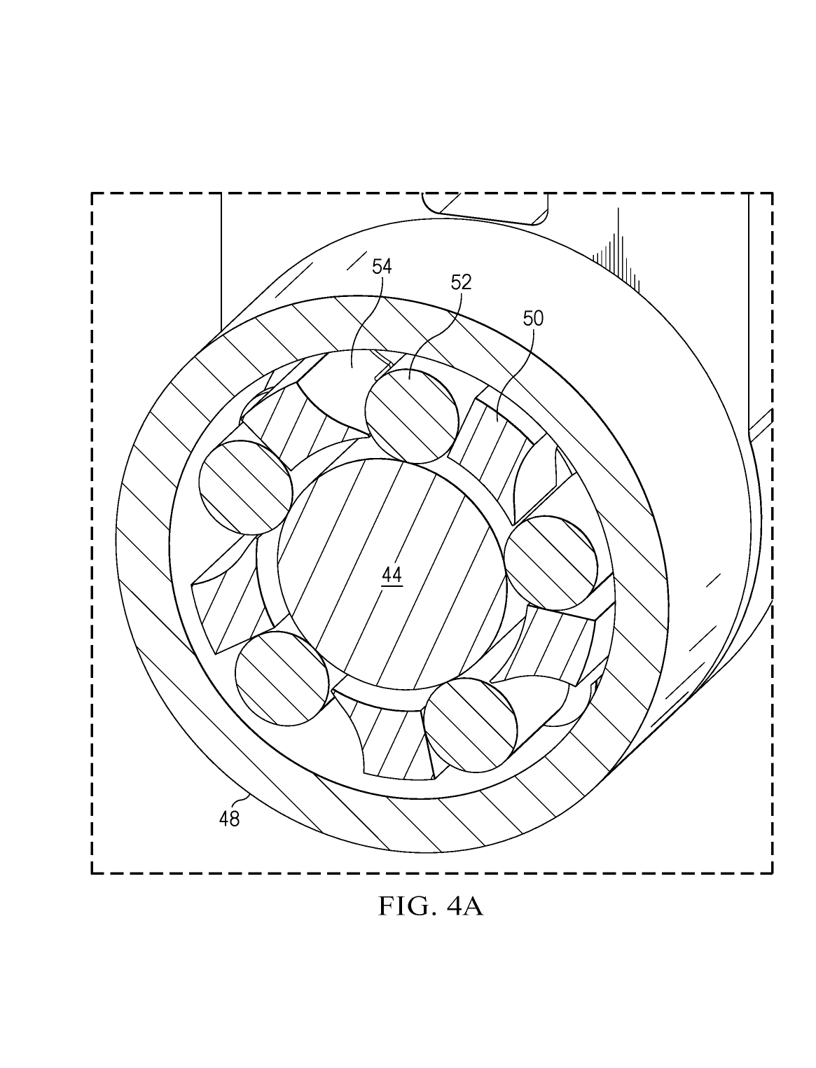

Referring now to FIGS. 4 and 4A, a side sectional view depicts the example embodiment of the variable torque hinge inserted onto the hinge axle. The sectional view of FIG. 4 depicts variable torque engine 40 having a sleeve 48 with plural internal splines 50 and plural bearings 52 inserted over axle 44. In various embodiments, splines 50 may couple to axle 44 or to sleeve 48. Bearings 52 are cylindrical in shape and sized to rotate within the channel defined by each of the opposing splines. When axle 44 rotates relative to main body 46 and sleeve 48 in a counterclockwise direction, bearings 52 are pushed by the rotation to bias against a vertical side of the spline 50 where space exists in the channel for the bearing to rotate. FIG. 4A depicts a detailed view of a spline 50 having an incline 54 at a side opposite the vertical surface. When axle 44 rotates clockwise, incline 54 works against bearing 52 to push bearing 52 outwards towards sleeve 48. The upward pressure of bearing 52 against sleeve 48 binds sleeve 48 to move with axle 44. This movement of sleeve 48 to rotate relative to the main body and bracket generates torque in that direction of rotation due to the friction of both ends of sleeve 48 working against the main body and bracket.

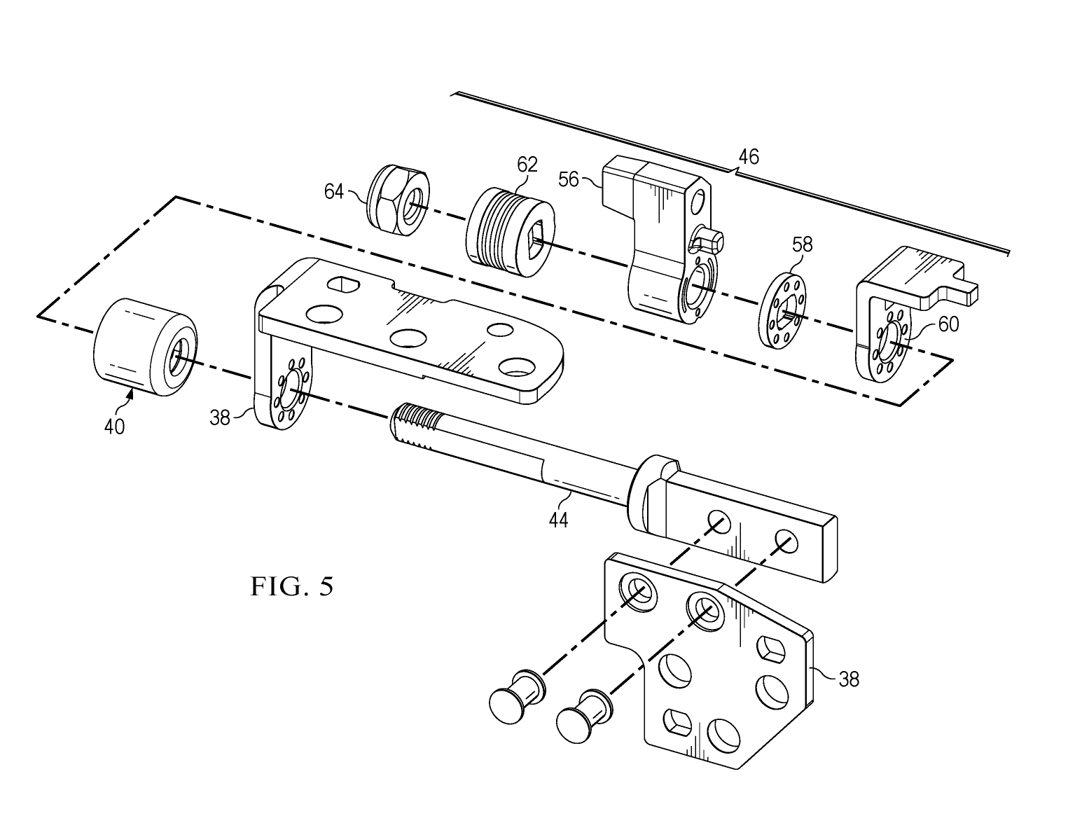

Referring now to FIG. 5, an exploded perspective view depicts an the example embodiment of the variable torque hinge. In the example embodiment, one bracket 38 couples directly to axle 44 and the other bracket 38 inserts onto axle 44. Variable torque engine 40 inserts over axle 44 to press against the bracket 38 that rotates on axle 44. A main body bracket 60 inserts onto axle 44 and presses against variable torque engine 40 with an extension engaging into the bracket 38 to hold the main body bracket and housing bracket at a common orientation. Main body 46 includes a dual-direction torque engine 62 that has a keyed insert to fit onto a keyed end of axle 44 so that dual direction torque engine 62 always rotates with axle 44. A nut 64 couples to threads on the end of axle 44 to compress dual direction torque engine 62 against a main body portion 56, a main body friction member 58, and a main body bracket 60. The dual direction torque generates torque in response to rotation of axle 44 in either direction. Nut 64 is tightened to determine the amount of torque created by both the dual-direction torque engine and the variable torque engine. In the example embodiment, dual-direction torque engine 62 is a set of friction washers, such as Belleville washers. In alternative embodiments, other types of friction arrangements may be used including dual-direction variable torque mechanisms.

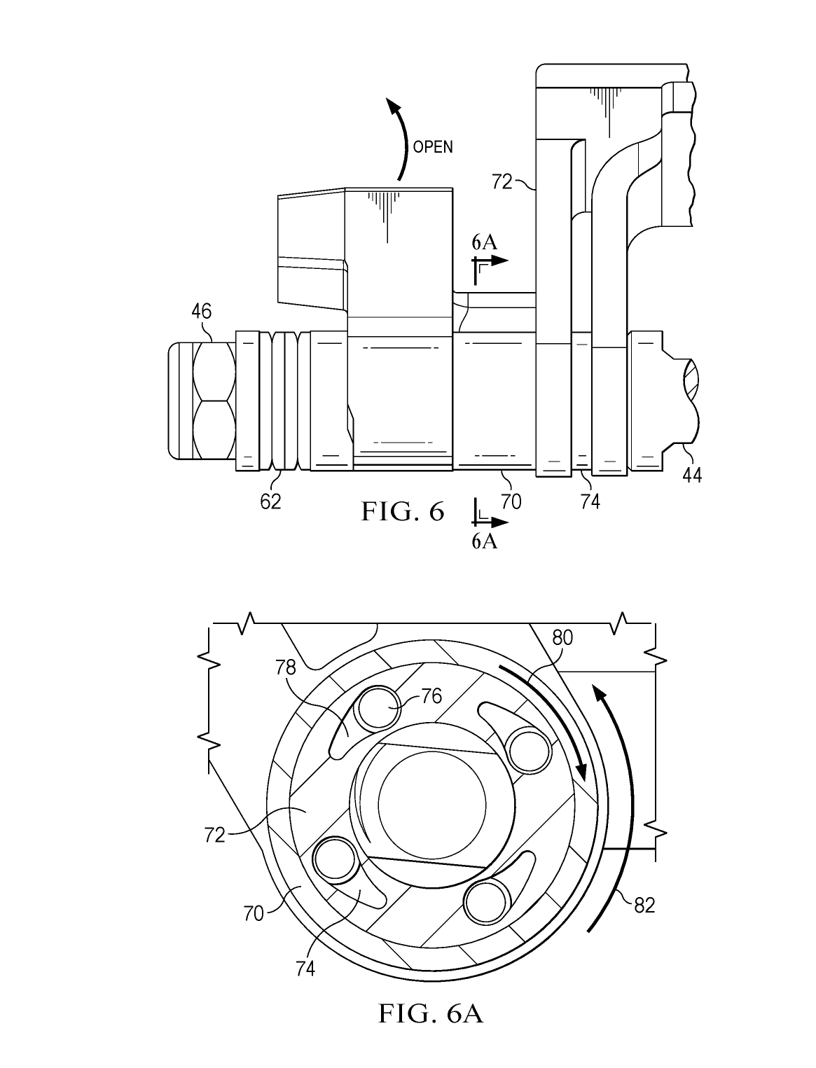

Referring now to FIGS. 6 and 6A, an alternative embodiment of the variable torque hinge is depicted rotating to an open position having near zero torque. FIG. 6 depicts a side view of the hinge having a variable torque engine 70 and dual-direction torque engine 62 when the hinge rotates in an open direction having a reduced torque. FIG. 6A depicts a sectional view of variable torque engine 70 having plural bearings 76 coupled into tear shaped openings 78 around axle 44. Rotation of the axle in an open direction shown by arrow 82 places a bias on the variable torque engine so that bearings 76 are in the largest diameter of the openings 78 and rotate as indicated by arrow 80 without locking relative to axle 44. Friction to resist rotation of axle 44 is provided by an inner friction member 74 but friction is not provided by the end of variable torque engine 70 against the bracket member 72. As is described above, in the open direction the placement of bearing 76 in an area where it supports rotation of the axle means that the axle rotates within the variable torque engine.

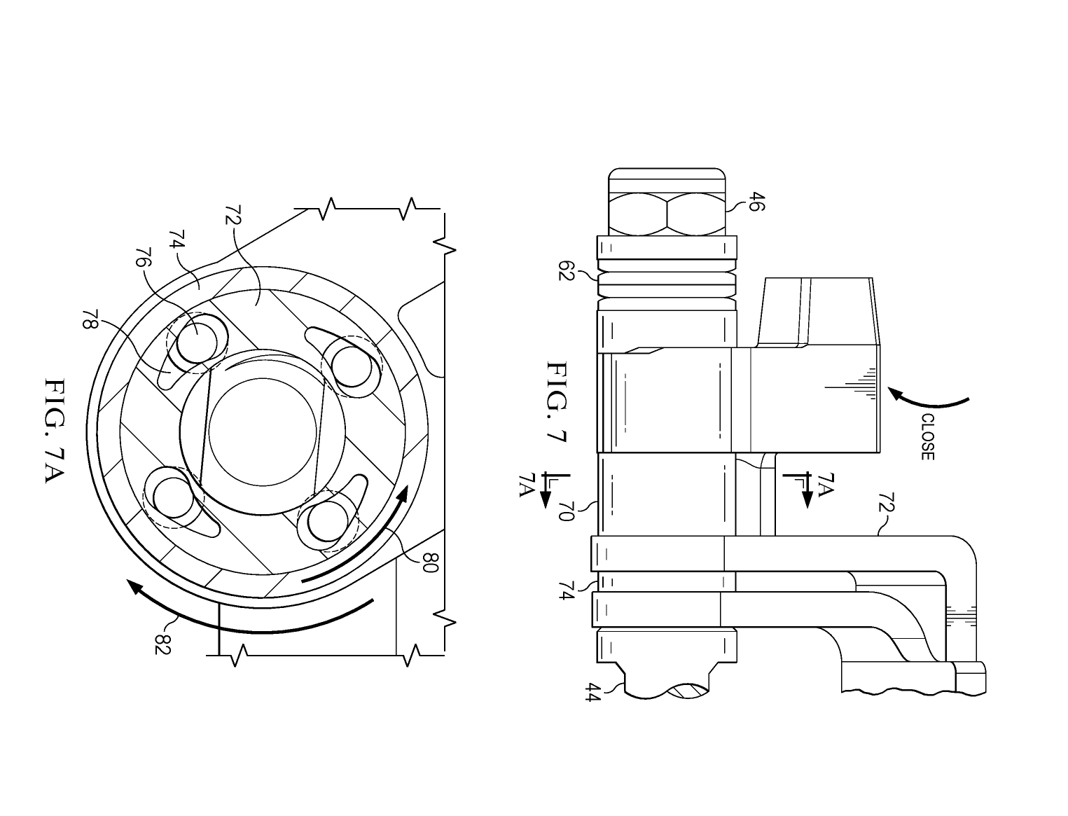

Referring now to FIGS. 7 and 7A, an alternative embodiment depicts the variable torque hinge rotating to a closed position and generating torque to resist rotation. During rotation in the closed direction, variable torque engine 70 rotates with axle 44 to generate torque in response to friction by moving relative to bracket member 72 and the main body. FIG. 7A depicts that rotation shown by arrow 82 places a bias on the variable torque engine so that bearings 76 engage in the smaller diameter portion of opening 78 and the variable torque engine rotates with the axle as shown by arrow 80. This rotation of the variable torque engine generates torque along both ends of the variable torque engine as it rotates with the axle and against the main body and hinge bracket member.

Although the present invention has been described in detail, it should be understood that various changes, substitutions and alterations can be made hereto without departing from the spirit and scope of the invention as defined by the appended claims.

What is claimed is:

1. An information handling system comprising:
a housing having a main portion rotationally coupled to a lid portion to rotate between closed and opened positions;
a processor coupled in the main portion and operable to execute instructions to process information;
a memory coupled in the main portion and interfaced with the processor to store the instructions and information;
a display coupled in the lid portion and interfaced with the processor, the display operable to present the information as visual images; and
a hinge coupled to the housing lid portion and the housing main portion by a first bracket and a second bracket, the first and second brackets rotating relative to each other about an axle, the axle having a variable torque engine resisting axle rotation in a first direction at a first torque and resisting axle rotation in a second direction opposite the first at a second torque of near zero torque relative to the first torque.

2. The information handling system of claim 1 further comprising:
a first body coupled to an end of the axle opposite the first and second brackets; and
a dual-direction torque engine coupled to the first body and resisting rotation of the axle by a third torque in both the first and second direction.

3. The information handling system of claim 2 wherein the dual-direction torque engine comprises:
friction washers inserted on the axle; and
a nut coupled to the axle to compress the friction washers.

4. The information handling system of claim 2 wherein the variable torque engine comprises:
a sleeve inserted on the axle and compressed between the first body and the first bracket; and
a bearing engaged in the sleeve and extending out an opening of the sleeve having a first width and a second width, the bearing rotating in the first width to free the sleeve relative to the axle, the bearing fixing the sleeve relative to the axle at the second width so that the sleeve rotates with the axle relative to the first body and the first bracket to generate torque from friction of the sleeve working against the first body and first bracket.

5. The information handling system of claim 2 wherein the variable torque engine comprises:
a sleeve inserted on the axle and compressed between the first body and the first bracket;
opposing splines coupled to the axle in the sleeve and extending from the axle towards the sleeve to define a channel, one side of the channel having an incline; and
a bearing disposed in the channel and biased away from the incline when the axle rotates in the second direction so the axle rotates relative to the sleeve, the bearing biased towards the incline when the axle rotates in the first direction so the sleeve rotates with the axle.

6. The information handling system of claim 5 wherein the sleeve compresses against both the first body and bracket to generate torque by friction of the sleeve rotating with the axle and relative to the first body and bracket.

7. The information handling system of claim 6 further comprising five splines coupled to the axle in the sleeve to define five channels, each channel having one side with the incline.

8. The information handling system of claim 7 further comprising five bearings, each bearing inserted in a channel.

9. The information handling system of claim 6 wherein the bearing comprises a cylindrical member sized to rotate in the channel when distal the incline.

10. A method for managing rotation of information handling system housing portions, the method comprising:
coupling a first bracket to a first housing portion and an axle;
coupling a second bracket to second housing portion and the axle;
coupling a dual-direction torque engine and first body to the axle, the dual-direction torque engine generating a first torque to resist rotation of the first bracket relative to the second bracket in both first and second rotational directions of the axle; and
coupling a variable torque engine to the axle between the first body and the first bracket, the variable torque engine resisting axle rotation in a first direction at a second torque and resisting axle rotation in a second direction opposite the first at a third torque of near zero torque relative to the second torque.

11. The method of claim 10 wherein the coupling the dual-direction torque engine further comprising:
coupling friction washers to the axle; and
compressing the friction washers with a nut coupled to an end of the axle opposite the first and second brackets.

12. The method of claim 10 further comprising:
inserting a bearing in an opening at an end of a sleeve;
inserting the sleeve onto the axle as the variable torque engine;
when rotating the axle in the first direction, biasing the bearing by the rotating into a first portion of the opening having a dimension of greater than the bearing so the sleeve is free to move relative to the axle; and
when rotating the axle in the second direction, biasing the bearing by the rotating into a second portion of the opening having a dimension of less than the bearing so the sleeve engages the axle to rotate with the axle.

13. The method of claim 12 further comprising:
compressing the sleeve at first and second ends; and
when rotating the axle in the second direction, generating torque by friction of the first and second ends of the sleeve.

14. The method of claim 10 further comprising:
forming plural channels in a sleeve, one side of each channel having an incline;
inserting a bearing in each channel;
when rotating the axle in the first direction, biasing the bearing by the rotating into a first portion of the channel having a dimension of greater than the bearing so the sleeve is free to rotate relative to the axle; and
when rotating the axle in the second direction, biasing the bearing by the rotating onto the incline and against the sleeve so the sleeve engages the axle to rotate with the axle.

15. The method of claim 14 further comprising:
compressing the sleeve at first and second ends; and
when rotating the axle in the second direction, generating torque by friction of the first and second ends of the sleeve.

16. A hinge comprising:
an axle;
a first bracket configured to couple to a first housing portion;
a second bracket configured to couple to a second housing portion, the first and second brackets rotating relative to each other about the axle;
a variable torque engine coupled to the axle and resisting axle rotation in a first direction at a first torque and resisting axle rotation in a second direction opposite the first at a second torque of near zero torque relative to the first torque.

17. The hinge of claim 16 further comprising:
a first body coupled to an end of the axle opposite the first and second brackets; and
a dual-direction torque engine coupled to the first body and resisting rotation of the axle by a third torque in both the first and second direction.

18. The hinge of claim 17 wherein the variable torque engine comprises:
a sleeve inserted on the axle and compressed between the first body and the first bracket;
opposing splines coupled to the axle in the sleeve and extending from the axle towards the sleeve to define a channel, one side of the channel having an incline; and
a bearing disposed in the channel and biased away from the incline when the axle rotates in the second direction so the axle rotates relative to the sleeve, the bearing biased towards the incline when the axle rotates in the first direction so the sleeve rotates with the axle.

19. The hinge of claim 18 wherein the sleeve compresses against both the first body and bracket to generate torque by friction of the sleeve rotating with the axle and relative to the first body and bracket.

20. The hinge of claim 17 wherein the variable torque engine comprises:
a sleeve inserted on the axle and compressed between the first body and the first bracket; and
a bearing engaged in the sleeve and extending out an opening of the sleeve having a first width and a second width, the bearing rotating in the first width to free the sleeve relative to the axle, the bearing fixing the sleeve relative to the axle at the second width so that the sleeve rotates with the axle relative to the first body and the first bracket to generate torque from friction of the sleeve working against the first body and first bracket.
